(19) United States
(12) Patent Application Publication
(10) Pub. No.: US 2026/0099713 A1
(43) Pub. Date: Apr. 9, 2026

(54) PREDICTION DEVICE, PREDICTION METHOD, AND NON-TRANSITORY COMPUTER READABLE MEDIUM STORING PREDICTION PROGRAM FOR SUPPORTING DECISION MAKING

(71) Applicant: NEC Corporation, Tokyo (JP)

(72) Inventors: Kosuke AKIMOTO, Tokyo (JP); Masafumi Oyamada, Tokyo (JP)

(73) Assignee: NEC Corporation, Tokyo (JP)

(21) Appl. No.: 19/338,191

(22) Filed: Sep. 24, 2025

(30) Foreign Application Priority Data
Oct. 8, 2024 (JP) 2024-176660

(51) Int. Cl. G06N 3/084; G06F 9/50

(52) U.S. Cl. CPC G06N 3/084; G06F 9/5027

(57) ABSTRACT

Provided is a technique for efficiently setting an appropriate number of epochs in learning of a language model. A prediction device includes an acquisition unit for acquiring a first pair including a calculation resource amount that is a constraint on a calculation resource amount used for learning processing of a language model and a target language resource amount that is a resource amount of an available target language, and a prediction unit for referring to a combination of a second pair and a second epoch number, and predicting a range of a first epoch number in which a loss in learning using the calculation resource amount and the target language resource amount included in the first pair becomes smaller.

### INCORPORATION BY REFERENCE

This application is based upon and claims the benefit of priority from Japanese patent application No. 2024-176660, filed on Oct. 8, 2024, the disclosure of which is incorporated herein in its entirety by reference.

### TECHNICAL FIELD

The present disclosure relates to a prediction device, a prediction method, and a prediction program for supporting decision making.

### BACKGROUND ART

A technique related to setting of the number of epochs in machine learning is known. For example, JP 2017-97807 A discloses an information processing device that sets the number of epochs based on a variance value of accuracy of a plurality of neural networks immediately before a loop start and results of neural network learning in a case where a loop of a genetic algorithm is performed on the plurality of neural networks.

### SUMMARY

However, in the information processing device described in JP 2017-97807 A, learning of a language model is not assumed. In the learning of the language model, as an example, the appropriate number of epochs changes according to the amount of text corpus used for learning. Therefore, a technique for efficiently setting an appropriate number of epochs in learning of a language model is required.

The present disclosure has been made in view of the above problems, and an example object thereof is to provide a technique for efficiently setting an appropriate number of epochs in learning of a language model.

A prediction device according to an example aspect of the present disclosure includes an acquisition means for acquiring a first pair including a calculation resource amount that is a constraint on a calculation resource amount used for learning processing of a language model for a target language and a target language resource amount that is a resource amount of the target language available for the learning processing, and a prediction means for referring to a combination of a second pair in which at least one of the calculation resource amount and the target language resource amount included in the first pair is different and a second epoch number in which a loss in learning using a calculation resource amount and a target language resource amount included in the second pair is smaller, and predicting a range of a first epoch number in which a loss in learning using the calculation resource amount and the target language resource amount included in the first pair is smaller.

A prediction method according to an example aspect of the present disclosure includes acquisition processing of acquiring, by at least one processor, a first pair including a calculation resource amount that is a constraint on a calculation resource amount used for learning processing of a language model for a target language and a target language resource amount that is a resource amount of the target language available for the learning processing, and prediction processing for referring, by the at least one processor, to a combination of a second pair in which at least one of the calculation resource amount and the target language resource amount included in the first pair is different and a second epoch number in which a loss in learning using a calculation resource amount and a target language resource amount included in the second pair is smaller, and predicting a range of a first epoch number in which a loss in learning using the calculation resource amount and the target language resource amount included in the first pair is smaller.

A prediction program according to an example aspect of the present disclosure is a program that causes a computer to function as a prediction device, the program causing the computer to function as an acquisition means for acquiring a first pair including a calculation resource amount that is a constraint on a calculation resource amount used for learning processing of a language model for a target language and a target language resource amount that is a resource amount of the target language available for the learning processing, and a prediction means for referring to a combination of a second pair in which at least one of the calculation resource amount and the target language resource amount included in the first pair is different and a second epoch number in which a loss in learning using a calculation resource amount and a target language resource amount included in the second pair is smaller, and predicting a range of a first epoch number in which a loss in learning using the calculation resource amount and the target language resource amount included in the first pair is smaller.

According to an example aspect of the present disclosure, there is an example effect that a technology for efficiently setting an appropriate number of epochs in learning of a language model can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of a prediction device according to the present disclosure;

FIG. 2 is a flowchart illustrating a flow of a prediction method according to the present disclosure;

FIG. 3 is a graph illustrating how the loss of an LLM changes in a case where the number of epochs is changed for each unique amount of a text corpus of a target language according to the present disclosure;

FIG. 4 is a graph illustrating a relationship between a unique amount of a text corpus of a target language and an appropriate number of epochs in a case where a calculation resource amount of processing of training an LLM is changed according to the present disclosure;

FIG. 5 is a block diagram illustrating a configuration of the prediction device according to the present disclosure;

FIG. 6 is a flowchart illustrating a flow of a prediction method according to the present disclosure; and

FIG. 7 is a block diagram illustrating a configuration of a computer that functions as the prediction device according to the present disclosure.

### EXAMPLE EMBODIMENT

Hereinafter, example embodiments of the present disclosure will be exemplified. However, the present disclosure is not limited to the following illustrative example embodiments, and various modifications can be made within a scope described in the claims. For example, example embodiments obtained by appropriately combining technologies (some or all of things or methods) adopted in the following illustrative example embodiments can also be included in the scope of the present disclosure. Example embodiments obtained by appropriately omitting some of the technologies adopted in the following illustrative example embodiments can also be included in the scope of the present disclosure. Effects mentioned in the following illustrative example embodiments are examples of effects expected in the illustrative example embodiments, and do not define extension of the present disclosure. In other words, example embodiments that do not provide the effects mentioned in the following illustrative example embodiments can also be included in the scope of the present disclosure.

### First Illustrative Example Embodiment

A first illustrative example embodiment that is an example of the example embodiments of the present disclosure will be described in detail with reference to the drawings. The present illustrative example embodiment is a basic form of each illustrative example embodiment to be described below. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technology illustrated in the drawings referred to for describing the present illustrative example embodiment can also be adopted in another illustrative example embodiment included in the present disclosure within a range in which no particular technical problem occurs.

### (Configuration of Prediction Device 1)

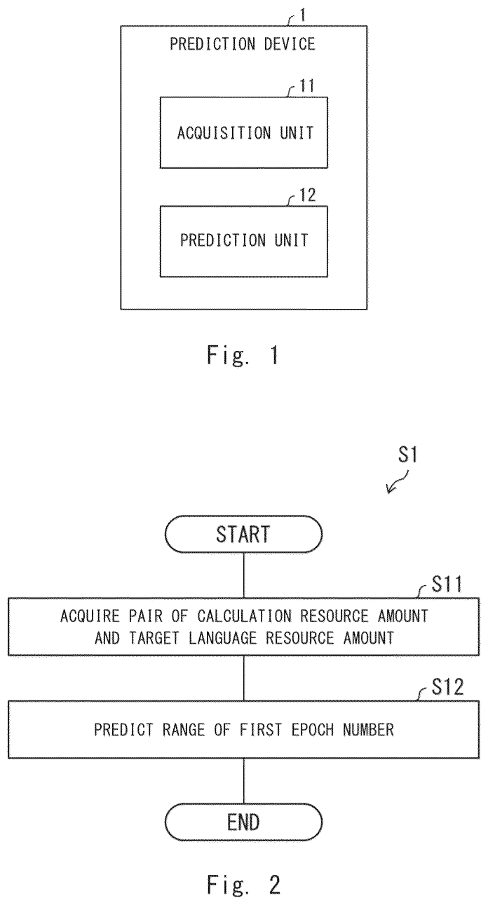

A configuration of a prediction device 1 will be described with reference to FIG. 1. FIG. 1 is a block diagram illustrating a configuration of the prediction device 1. As illustrated in FIG. 1, the prediction device 1 includes an acquisition unit 11 and a prediction unit 12. The acquisition unit 11 and the prediction unit 12 implement an acquisition means and a prediction means, in the present illustrative example embodiment.

### (Acquisition Unit 11)

The acquisition unit 11 acquires a first pair including a calculation resource amount that is a constraint on a calculation resource amount used for learning processing of a language model for a target language and a target language resource amount that is a resource amount of the target language available in the learning processing. The acquisition unit 11 supplies the acquired first pair to the prediction unit 12.

### (Prediction Unit 12)

The prediction unit 12 refers to a combination of a second pair having different at least one of the calculation resource amount and the target language resource amount included in the first pair acquired by the acquisition unit 11 and a second epoch number in which the loss in learning using the calculation resource amount and the target language resource amount included in the second pair becomes smaller, and predicts the range of a first epoch number in which the loss in learning using the calculation resource amount and the target language resource amount included in the first pair becomes smaller.

### (Effects of Prediction Device 1)

As described above, the prediction device 1 employs a configuration including the acquisition unit 11 that acquires the first pair including the calculation resource amount that is a constraint on a calculation resource amount used for learning processing of a language model for a target language and the target language resource amount that is a resource amount of the target language available for the learning processing, and the prediction unit 12 that refers to a combination of the second pair in which at least one of the calculation resource amount and the target language resource amount included in the first pair acquired by the acquisition unit 11 is different and the second epoch number in which a loss in learning using the calculation resource amount and the target language resource amount included in the second pair is smaller, and predicts the range of the first epoch number in which a loss in learning using the calculation resource amount and the target language resource amount included in the first pair is smaller.

Therefore, according to the prediction device 1, it is possible to efficiently set an appropriate number of epochs in learning of a language model.

### (Flow of Prediction Method S1)

A flow of a prediction method S1 will be described with reference to FIG. 2. FIG. 2 is a flowchart illustrating the flow of the prediction method S1. As illustrated in FIG. 2, the prediction method S1 includes acquisition processing S11 and prediction processing S12.

### (Acquisition Processing S11)

In the acquisition processing S11, the acquisition unit 11 acquires a first pair of a calculation resource amount that is a constraint on a calculation resource amount used for learning processing of a language model for a target language and a target language resource amount that is a resource amount of the target language available in the learning processing. The acquisition unit 11 supplies the acquired first pair to the prediction unit 12.

### (Prediction Processing S12)

The prediction unit 12 refers to a combination of a second pair having different at least one of the calculation resource amount and the target language resource amount included in the first pair acquired by the acquisition unit 11 and a second epoch number in which the loss in learning using the calculation resource amount and the target language resource amount included in the second pair becomes smaller, and predicts the range of a first epoch number in which the loss in learning using the calculation resource amount and the target language resource amount included in the first pair becomes smaller.

### (Effect of Prediction Method S1)

As described above, in the prediction method S1, a configuration is adopted in which the acquisition unit 11 performs the acquisition processing S11 of acquiring the first pair including the calculation resource amount that is a constraint on a calculation resource amount used for learning processing of a language model for a target language and the target language resource amount that is a resource amount of the target language available for the learning processing, and the prediction unit 12 performs the prediction processing S12 of referring to a combination of the second pair in which at least one of the calculation resource amount and the target language resource amount included in the first pair acquired by the acquisition unit 11 is different and the second epoch number in which a loss in learning using the calculation resource amount and the target language resource amount included in the second pair is smaller, and predicting the range of the first epoch number in which a loss in learning using the calculation resource amount and the target language resource amount included in the first pair is smaller. Therefore, according to the prediction method S1, the same effect as that of the prediction device 1 described above can be obtained.

### Second Illustrative Example Embodiment

A second illustrative example embodiment that is an example of the example embodiments of the present disclosure will be described in detail with reference to the drawings. Components that have the same functions as the components described in the above-described illustrative example embodiment are denoted by the same reference signs, and description of the components will be appropriately omitted. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technique illustrated in each of the drawings referred to for description of the present illustrative example embodiment can be employed in the other illustrative example embodiments included in the present disclosure within a range in which no particular technical problem occurs.

Learning a language model (hereinafter, also referred to as “LLM (Large Language Models)”) requires a large text corpus. However, languages other than English have a relatively small text corpus. Therefore, the following method is known as a method for training a language model using a language having a small resource amount of a text corpus as a target language.
Method of performing learning by repeatedly using the same text corpus a plurality of times (multi-epoch learning)
Method of performing learning using a text corpus of another language different from the target language in addition to a text corpus of the target language (multilingual learning)
Method of performing two-stage learning by changing in stages a language ratio between a target language and another language in multilingual learning (two-stage learning)

However, in a case where the language model is trained by combining the above-described methods, the learning setting (hyperparameter) increases, and thus, the cost increases if exhaustive search is performed.

Therefore, the engineer who trains the language model has heuristically narrowed down the search space based on the analysis result obtained in the past regarding the performance change of the language model by the learning setting. However, the analysis related to the learning setting of the language model performed in the past is limited, and there is a problem that the optimal search space cannot be narrowed in a case where the LLM is trained by combining the above-described methods.

Therefore, the inventors of the present disclosure have conducted studies to narrow down a search space of a learning setting expected to obtain high performance in a case where a language model having a language with a small resource amount as a target language is trained by using a combination of a part or all of the multi-epoch learning, the multilingual learning, and the two-stage learning described above.

As an example, the inventor has found that a smaller unique amount (a quantity that does not include repetition in a case where the number of epochs is plural) of the text corpus of the target language results in a monotonically larger appropriate number of epochs with smaller losses in learning. Furthermore, the present inventor has found that if the calculation resource amount of processing for training an LLM decreases, the appropriate number of epochs also monotonously decreases.

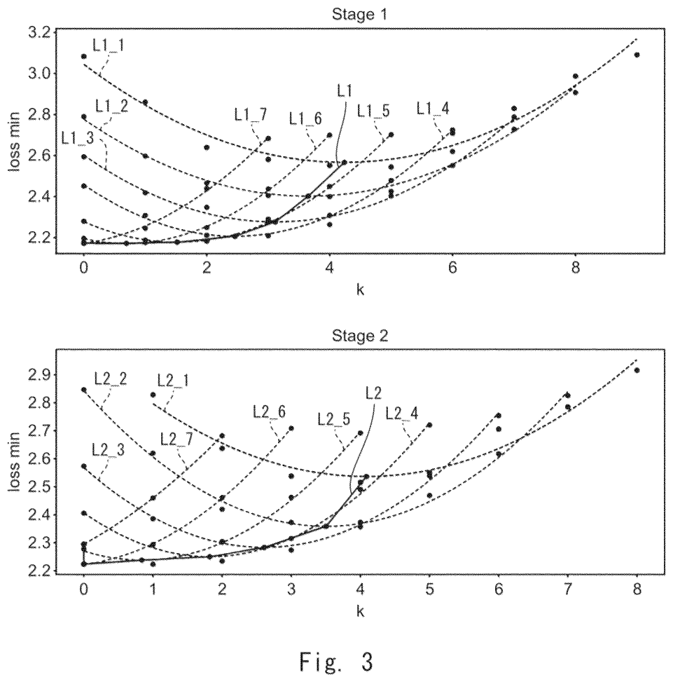

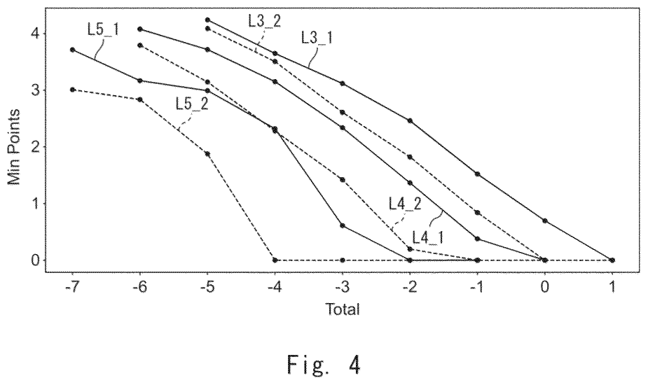

FIGS. 3 and 4 illustrate graphs that are the basis of the findings obtained by the present inventor. FIG. 3 is a graph illustrating how the loss of an LLM changes in a case where the number of epochs is changed for each unique amount of the text corpus of the target language. FIG. 4 is a graph illustrating a relationship between the unique amount of the text corpus of the target language and the appropriate number of epochs in a case where the calculation resource amount of the processing of training an LLM is changed.

In the graph illustrated in FIG. 3, the horizontal axis represents a logarithmic value with a base of 2 of the number of epochs. The vertical axis represents a loss of an LLM, and a smaller value indicates better performance of an LLM. The upper graph of FIG. 3 is a graph in the case of multilingual (including single-language) one-stage learning, and the lower graph of FIG. 3 is a graph in the case of multilingual two-stage learning.

Curves L1_1 to L1_7 and curves L2_1 to L2_7 in the graph illustrated in FIG. 3 are curves obtained by fitting a change in the loss of an LLM in a case where the LLM is trained with different unique amounts (unique amounts of the text corpus of the target language) by a quadratic function related to the logarithmic value with a base of 2 of the number of epochs.

Curves L1 and L2 in the graph illustrated in FIG. 3 are curves connecting the minimum points of curves fitted with a quadratic function for each unique amount of the text corpus of the target language (however, since the number of epochs is not smaller than 1, minimum points in a range where the value of the horizontal axis is 0 or more are connected).

In the graph illustrated in FIG. 4, the horizontal axis represents a logarithmic value with a base of 2 of the magnitude of the unique amount of the text corpus of the target language (the amount in a case where the unique amount of the text corpus is sufficient is set to 0) with respect to the reference amount. The vertical axis is the logarithmic value with a base of 2 of the appropriate number of epochs.

The line L3_1 indicates the case of the multilingual one-stage learning with the calculation resource amount of 10\hat{ }18 FLOPS, and the line L3_2 indicates the case of the multilingual two-stage learning with the calculation resource amount of 10\hat{ }18 FLOPS. The line L4_1 indicates the case of the multilingual one-stage learning with the calculation resource amount of ¼×10\hat{ }18 FLOPS, and the line L4_2 indicates the case of the multilingual two-stage learning with the calculation resource amount of ¼×10\hat{ }18 FLOPS. The line L5_1 indicates the case of the multilingual one-stage learning with the calculation resource amount of 1/16×10\hat{ }18 FLOPS, and the line L5_2 indicates the case of the multilingual two-stage learning with the calculation resource amount of 1/16×10\hat{ }18 FLOPS.

As illustrated in FIG. 4, the appropriate number of epochs increases as the unique amount of the text corpus of the target language decreases, and decreases as the calculation resource amount of the processing for training the LLM decreases. As illustrated in FIG. 4, the feature does not depend on the learning method.

Furthermore, from FIG. 4, the appropriate number of epochs is calculated by the following Expression (1).

Appropriate number of epochs=f(log T−g(log CR)) (1)

Here, T is a unique amount of the text corpus of the target language, and CR is a calculation resource amount of processing for training the LLM. Furthermore, g (log CR) is calculated by the following Expression (2).

$$g ( log CR ) = alogCR \qquad ( 2 )$$

Here, a is a coefficient.

The prediction device 1A and each processing by the prediction device 1A described below are based on the above-described knowledge, and are based on the inventor's unique point of view.

### (Outline of Prediction Device 1A)

The prediction device 1A is a device that predicts a range of an appropriate number of epochs in learning of an LLM. The appropriate number of epochs is the number of epochs in which a loss in learning is smaller. The range of the appropriate number of epochs is a range in which the appropriate number of epochs is included, and may be a value equal to or greater than a certain value (greater than a certain value), a value equal to or less than a certain value (less than a certain value), and combinations thereof, or may be the appropriate number of epochs itself.

Specifically, the prediction device 1A predicts a range RA of the first epoch number in which the loss in learning using a calculation resource amount CR which is a constraint on a calculation resource amount used for the learning processing of the LLM for the target language and a target language resource amount T which is a resource amount of the target language available in the learning processing becomes small. The first epoch number may be the number of epochs in which a loss in learning using the calculation resource amount CR and the target language resource amount T is minimized. With this configuration, the prediction device 1A can predict the range of the number of epochs in which the loss in learning is minimized.

The calculation resource amount CR, which is a constraint on the calculation resource amount used for the LLM learning processing for the target language, is the resource amount that can be used for the learning processing by the device that performs the LLM learning processing, and as an example, an amount obtained by measuring the total amount of calculation that can be used for the learning processing in units of a floating-point operation (FLOP) can be cited.

The target language resource amount T, which is the resource amount of the target language available in the learning processing, is the unique amount (a quantity that does not include repetition in a case where the number of epochs is more than one) of the text corpus of the target language that has been collected and can be used to perform the LLM learning processing. An example of the target language resource amount T is the unique amount of the text corpus of all the target languages existing on the earth.

The prediction device 1A refers to a combination of a second pair PA2 in which at least one of the calculation resource amount CR and the target language resource amount T included in the first pair PA1 is different, and the second epoch number in which the loss in learning using the calculation resource amount CR and the target language resource amount T included in the second pair PA2 becomes smaller, and predicts the range RA of the first epoch number.

The calculation resource amount CR and the target language resource amount T included in the second pair PA2 are not particularly limited, but as an example, the calculation resource amount CR included in the second pair PA2 is smaller than the calculation resource amount CR included in the first pair PA1. As another example, the target language resource amount T included in the second pair PA2 is smaller than the target language resource amount T included in the first pair PA1.

As described above, the range RA of the first epoch number predicted by the prediction device 1A is also applicable to the number of epochs in any learning method. For example, the range RA of the first epoch number predicted by the prediction device 1A may be configured to predict the range of the first epoch number in a case where the LLM is trained using a plurality of languages.

### (Configuration of Prediction Device 1A)

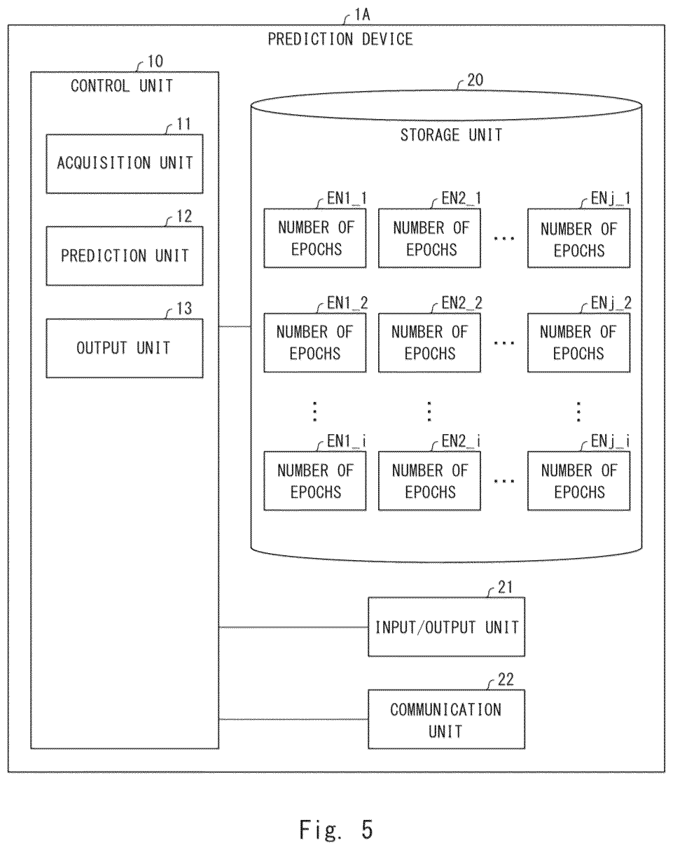

A configuration of a prediction device 1A will be described with reference to FIG. 5. FIG. 5 is a block diagram illustrating a configuration of the prediction device 1A. As illustrated in FIG. 5, the prediction device 1A includes a control unit 10, a storage unit 20, an input/output unit 21, and a communication unit 22.

### (Storage Unit 20)

The storage unit 20 stores data to be referred to by the control unit 10. As an example, the storage unit 20 stores a plurality of epoch numbers (second epoch numbers) EN.

Each of the plurality of second epoch numbers EN is an epoch number in which a loss in learning using the calculation resource amount CR and the target language resource amount T included in each of the plurality of second pairs PA2 becomes smaller. Hereinafter, the second epoch number EN in which the loss in learning using the calculation resource amount CR and the target language resource amount T included in the second pair PA2 becomes smaller is also referred to as a second epoch number EN relevant to the calculation resource amount CR and the target language resource amount T.

As an example, the epoch number EN1_1 is the second epoch number relevant to the calculation resource amount CR1 and the target language resource amount T1. As another example, the epoch number EN2_1 is the second epoch number relevant to the calculation resource amount CR2 and the target language resource amount T1. As still another example, the epoch number EN1_2 is the second epoch number relevant to the calculation resource amount CR1 and the target language resource amount T2.

Each of the plurality of second epoch numbers EN may be calculated by the control unit 10 from each of the plurality of second pairs PA2, or may be stored in the storage unit 20 in advance.

In the case of the configuration in which the control unit 10 performs calculation from each of the plurality of second pairs PA2, the control unit 10 trains the LLM by changing the hyperparameter using the calculation resource amount CR and the target language resource amount T included in each of the plurality of second pairs PA2. Examples of hyperparameters include the number of epochs, LLM model size, and number of training steps (in the case of two-stage learning, the ratio of the length of learning in the first stage and the ratio of the target language resource amount T in the first stage and the second stage). Then, the control unit 10 stores the number of epochs in which the loss is minimized in the storage unit 20 as the second epoch number EN. That is, the second epoch number EN is the number of epochs in which the loss in learning using the calculation resource amount CR and the target language resource amount T included in the second pair is minimized. With this configuration, the prediction device 1A can predict the range of the number of epochs in which the loss in learning is minimized also for the first epoch number to which the second epoch number EN is referred.

As another example, the storage unit 20 stores the first pair PA1, the second pair PA2, and the range RA of the first epoch number (not illustrated in FIG. 5).

### (Input/Output Unit 21)

The input/output unit 21 is an interface with an input device that receives an input of data and an output device that outputs data. Examples of the input device include, but are not limited to, a microphone, a camera, a line-of-sight input device, a keyboard, and a touch pad. Examples of the output device include, but are not limited to, a speaker and a liquid crystal display.

### (Communication Unit 22)

The communication unit 22 is an interface for transmitting and receiving data via a network. Examples of the communication unit 22 include, but are not limited to, communication chips in various communication standards such as Ethernet (registered trademark), Wi-Fi (registered trademark), and wireless communication standards of mobile data communication networks, and connectors compliant with USB.

### (Control Unit 10)

The control unit 10 controls each component included in the prediction device 1A. The control unit 10 includes an acquisition unit 11, a prediction unit 12, and an output unit 13. The acquisition unit 11, the prediction unit 12, and the output unit 13 implement acquisition means, prediction means, and output means in the present illustrative example embodiment.

### (Acquisition Unit 11)

The acquisition unit 11 acquires data supplied from the input/output unit 21 or the communication unit 22. The acquisition unit 11 stores the acquired data in the storage unit 20. As an example, the acquisition unit 11 acquires a first pair PA1 including a calculation resource amount CR which is a constraint on a calculation resource amount used for the learning processing of the LLM for the target language and a target language resource amount T which is a resource amount of the target language available in the learning processing.

### (Prediction Unit 12)

The prediction unit 12 predicts the range RA of the first epoch number. The prediction unit 12 stores the predicted range RA of the first epoch number in the storage unit 20. As an example, the prediction unit 12 refers to a combination of the second pair PA2 and the second epoch number EN, and predicts the range RA of the first epoch number.

As an example, the prediction unit 12 predicts the range RA of the first epoch number by using a monotonic change in the first epoch number for each of the calculation resource amount CR and the target language resource amount T.

For example, assuming that the first epoch number is k, in a case where the target language resource amount T included in the first pair PA1 and the target language resource amount T included in the second pair PA2 are the same, the calculation resource amount included in the second pair PA2 is a calculation resource amount CR′ smaller than the calculation resource amount CR included in the first pair PA1, and the value of the second epoch number EN relevant to the second pair PA2 is k′, the prediction unit 12 predicts k>k′ as the range RA of the first epoch number k. In this configuration, since the prediction unit 12 predicts the range RA of the first epoch number k with reference to the second epoch number EN with the calculation resource amount CR′ smaller than the calculation resource amount CR included in the first pair PA1, the range RA of the first epoch number k can be efficiently predicted.

On the other hand, assuming that the first epoch number is k, in a case where the target language resource amount T included in the first pair PA1 and the target language resource amount T included in the second pair PA2 are the same, the calculation resource amount included in the second pair PA2 is a calculation resource amount CR′ larger than the calculation resource amount CR included in the first pair PA1, and the value of the second epoch number EN relevant to the second pair PA2 is k′, the prediction unit 12 predicts k<k′ as the range RA of the first epoch number k.

Assuming that the first epoch number is k, in a case where the calculation resource amount CR included in the first pair PA1 and the calculation resource amount CR included in the second pair PA2 are the same, and the value of the second epoch number EN relevant to the target language resource amount T′ smaller than the target language resource amount T included in the first pair PA1 is k′, the prediction unit 12 predicts k>k′ as the range RA of the first epoch number k.

On the other hand, assuming that the first epoch number is k, in a case where the calculation resource amount CR included in the first pair PA1 and the calculation resource amount CR included in the second pair PA2 are the same, and the value of the second epoch number EN relevant to the target language resource amount T′ larger than the target language resource amount T included in the first pair PA1 is k′, the prediction unit 12 predicts k<k′ as the range RA of the first epoch number k.

As another example, for example, the prediction unit 12 predicts the range RA of the first epoch number using a calculation model that calculates the following Expression (3) with the first epoch number as k.

$$k = f ( CR , T ) = exp ( p\_ 0 \times max ( p\_ 1 \times log CR + p\_ 2 - log T , 0 ) ) \qquad ( 3 )$$

Here, p_0, p_1, and p_2 are parameters. As an example of a method of estimating the parameter, there is a method of estimating the parameter by updating the value of the parameter by a gradient method or the like so that the following Expression (4) decreases using a least squares method in a case where the calculation resource amount is CRⱼ, the target language resource amount is T_{j,i}, and the value of the relevant second epoch number ENj_i is k_{j,i}.

$$\begin{matrix}[ Math . 1 ] & \\ {\sum }_{i = 1}^{N} {\sum }_{j = 1}^{M} {( {k}_{j , i} - f ( {CR}_{j} , {T}_{j , i} ) )}^{2} & ( 4 )\end{matrix}$$

As described above, the prediction unit 12 can efficiently predict the range RA of the first epoch number by predicting the range RA of the first epoch number using the fact that the first epoch number monotonously changes with respect to each of the calculation resource amount CR and the target language resource amount T.

### (Output Unit 13)

The output unit 13 outputs data via the input/output unit 21 or the communication unit 22. As an example, the output unit 13 outputs at least one of the referred second pair PA2 and the second epoch number EN relevant to the second pair PA2, and the range RA of the first epoch number. With this configuration, the output unit 13 can notify the user of at least one of the predicted range RA of the first epoch number, and the second pair PA2 referred to for predicting the range RA of the first epoch number and the second epoch number EN relevant to the second pair PA2.

### (Processing Executed by Prediction Device 1A)

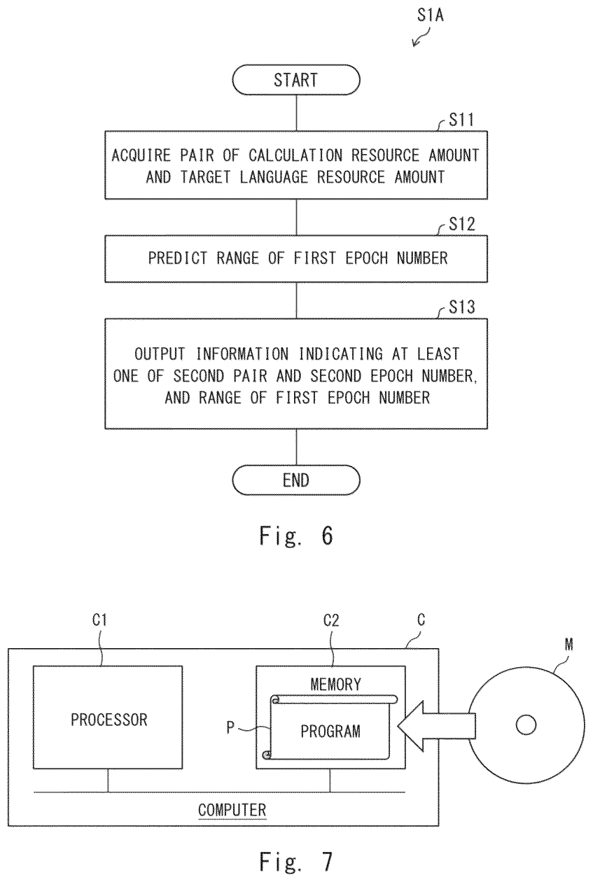

A flow of processing (prediction method SIA) performed by the prediction device 1A will be described with reference to FIG. 6. FIG. 6 is a flowchart illustrating a flow of the prediction method SIA.

### (Acquisition Processing S11)

In the acquisition processing S11, the acquisition unit 11 acquires a first pair PA1 including a calculation resource amount CR which is a constraint on a calculation resource amount used for the learning processing of the LLM for the target language and a target language resource amount T which is a resource amount of the target language available in the learning processing. The acquisition unit 11 stores the acquired first pair PA1 in the storage unit 20.

### (Prediction Processing S12)

In the prediction processing S12, the prediction unit 12 refers to a combination of the second pair PA2 and the second epoch number EN, and predicts the range RA of the first epoch number. The prediction unit 12 stores the predicted range RA of the first epoch number in the storage unit 20. As described above, for each of the calculation resource amount CR and the target language resource amount T included in the second pair PA2, the prediction unit 12 may predict the range RA of the first epoch number by using the monotonic change in the first epoch number, or may predict the range RA of the first epoch number by using the calculation model.

### (Output Processing S13)

In the output processing S13, the output unit 13 outputs at least one of the referred second pair PA2 and the second epoch number EN relevant to the second pair PA2, and the range RA of the first epoch number.

### (Application Example of Prediction Device 1A)

For example, the prediction device 1A may train an LLM by using the calculation resource amount CR and the target language resource amount T included in the first pair PA1 and the range RA of the first epoch number. As a method of training the LLM, a known method may be used. In a case where the prediction device 1A trains the LLM, the prediction device 1A may train the LLM after performing processing of determining various learning settings such as a model size of the LLM. As a result, the prediction device 1A can reduce the search space for changing the number of epochs in order to generate a higher-performance LLM.

The prediction device 1A may instruct an external device different from the prediction device 1A to train the LLM. In this case, the prediction device 1A may instruct an external device to narrow a range for selecting various learning settings using the predicted range RA of the first epoch number. With this configuration, the prediction device 1A can reduce the search space for changing the number of epochs with respect to the external device.

### (Effects of Prediction Device 1A)

As described above, the prediction device 1A refers to the combination of the calculation resource amount CR and the target language resource amount T included in the second pair PA2 and the relevant second epoch number, and predicts the range RA of the first epoch number in which the loss in learning using the calculation resource amount CR and the target language resource amount T included in the first pair decreases. As described above, if the calculation resource amount CR decreases, the appropriate number of epochs also monotonously decreases, and if the target language resource amount T decreases, the appropriate number of epochs monotonously increases. Therefore, the prediction device 1A can compare the calculation resource amount CR included in the second pair PA2 with the calculation resource amount CR included in the first pair PA1, can compare the target language resource amount T included in the second pair PA2 with the target language resource amount T included in the first pair PA1, can predict the range of the first epoch number from the comparison result and the second epoch number, and can narrow the search range, so that the appropriate number of epochs can be efficiently set in the learning of the LLM.

### [Achievement Example by Software]

Some or all of the functions of the prediction devices 1 and 1A (hereinafter, also referred to as “each of the above devices”) may be implemented by hardware such as an integrated circuit (IC chip) or may be implemented by software.

In the latter case, each of the above devices is achieved by, for example, a computer that executes a command of a program as software for achieving each function. An example of such a computer (hereinafter, referred to as a computer C) is illustrated in FIG. 7. FIG. 7 is a block diagram illustrating a hardware configuration of the computer C functioning as each of the above devices.

The computer C includes at least one processor C1 and at least one memory C2. A program P causing the computer C to operate as each of the above devices is recorded in the memory C2. In the computer C, by the processor C1 reading the program P from the memory C2 and executing the program P, each function of each of the above devices is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used. The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### [Supplementary Information 1]

The present disclosure includes technologies described in the following Supplementary Notes. However, the present disclosure is not limited to the techniques described in the following supplementary notes, and various modifications can be made within the scope described in the claims.

### [Supplementary Information A]

The present disclosure includes technologies described in the following Supplementary Notes. However, the present disclosure is not limited to the techniques described in the following supplementary notes, and various modifications can be made within the scope described in the claims.

### (Supplementary Note A1)

A prediction device including:
an acquisition means for acquiring a first pair including a calculation resource amount that is a constraint on a calculation resource amount used for learning processing of a language model for a target language and a target language resource amount that is a resource amount of the target language available for the learning processing; and
a prediction means for referring to a combination of a second pair in which at least one of the calculation resource amount and the target language resource amount included in the first pair is different and a second epoch number in which a loss in learning using a calculation resource amount and a target language resource amount included in the second pair is smaller, and predicting a range of a first epoch number in which a loss in learning using the calculation resource amount and the target language resource amount included in the first pair is smaller.

### (Supplementary Note A2)

The prediction device according to Supplementary Note A1, in which the prediction means predicts a range of the first epoch number by using a monotonic change in the first epoch number for each of the calculation resource amount and the target language resource amount.

### (Supplementary Note A3)

The prediction device according to Supplementary Note A1, in which the calculation resource amount included in the second pair is smaller than the calculation resource amount included in the first pair.

### (Supplementary Note A4)

The prediction device according to any one of Supplementary Notes A1 to A3, in which
the first epoch number is a number of epochs in which a loss in learning using the calculation resource amount and the target language resource amount included in the first pair is minimized, and
the second epoch number is a number of epochs in which a loss in learning using the calculation resource amount and the target language resource amount included in the second pair is minimized.

### (Supplementary Note A5)

The prediction device according to any one of Supplementary Note A1 to A4, further including an output means for outputting information indicating at least one of the second pair and the second epoch number relevant to the second pair, and a range of the first epoch number.

### [Supplementary Information B]

The present disclosure includes technologies described in the following Supplementary Notes. However, the present disclosure is not limited to the techniques described in the following supplementary notes, and various modifications can be made within the scope described in the claims.

### (Supplementary Note B1)

A prediction method including:
acquisition processing of acquiring, by at least one processor, a first pair including a calculation resource amount that is a constraint on a calculation resource amount used for learning processing of a language model for a target language and a target language resource amount that is a resource amount of the target language available for the learning processing; and
prediction processing for referring, by the at least one processor, to a combination of a second pair in which at least one of the calculation resource amount and the target language resource amount included in the first pair is different and a second epoch number in which a loss in learning using a calculation resource amount and a target language resource amount included in the second pair is smaller, and predicting a range of a first epoch number in which a loss in learning using the calculation resource amount and the target language resource amount included in the first pair is smaller.

### (Supplementary Note B2)

The prediction method according to Supplementary Note B1, in which in the prediction processing, the at least one processor predicts a range of the first epoch number by using a monotonic change in the first epoch number for each of the calculation resource amount and the target language resource amount.

### (Supplementary Note B3)

The prediction method according to Supplementary Note B1, in which the calculation resource amount included in the second pair is smaller than the calculation resource amount included in the first pair.

### (Supplementary Note B4)

The prediction method according to any one of Supplementary Notes B1 to B3, in which
the first epoch number is a number of epochs in which a loss in learning using the calculation resource amount and the target language resource amount included in the first pair is minimized, and
the second epoch number is a number of epochs in which a loss in learning using the calculation resource amount and the target language resource amount included in the second pair is minimized.

### (Supplementary Note B5)

The prediction method according to any one of Supplementary Note B1 to B4, further including output processing of outputting, by the at least one processor, information indicating at least one of the second pair and the second epoch number relevant to the second pair, and a range of the first epoch number.

### [Supplementary Information C]

The present disclosure includes technologies described in the following Supplementary Notes. However, the present disclosure is not limited to the techniques described in the following supplementary notes, and various modifications can be made within the scope described in the claims.

### (Supplementary Note C1)

A prediction program for causing a computer to function as a prediction device, wherein the computer functions as:
an acquisition means for acquiring a first pair including a calculation resource amount that is a constraint on a calculation resource amount used for learning processing of a language model for a target language and a target language resource amount that is a resource amount of the target language available for the learning processing; and
a prediction means for referring to a combination of a second pair in which at least one of the calculation resource amount and the target language resource amount included in the first pair is different and a second epoch number in which a loss in learning using a calculation resource amount and a target language resource amount included in the second pair is smaller, and predicting a range of a first epoch number in which a loss in learning using the calculation resource amount and the target language resource amount included in the first pair is smaller.

### (Supplementary Note C2)

The prediction program according to Supplementary Note C1, in which the prediction means predicts a range of the first epoch number by using a monotonic change in the first epoch number for each of the calculation resource amount and the target language resource amount.

### (Supplementary Note C3)

The prediction program according to Supplementary Note C1, in which the calculation resource amount included in the second pair is smaller than the calculation resource amount included in the first pair.

### (Supplementary Note C4)

The prediction program according to any one of Supplementary Notes C1 to C3, in which
the first epoch number is a number of epochs in which a loss in learning using the calculation resource amount and the target language resource amount included in the first pair is minimized, and
the second epoch number is a number of epochs in which a loss in learning using the calculation resource amount and the target language resource amount included in the second pair is minimized.

### (Supplementary Note C5)

The prediction program according to any one of Supplementary Note C1 to C4, in which the computer further functions as an output means for outputting information indicating at least one of the second pair and the second epoch number relevant to the second pair, and a range of the first epoch number.

### [Supplementary Information D]

The present disclosure includes technologies described in the following Supplementary Notes. However, the present disclosure is not limited to the techniques described in the following supplementary notes, and various modifications can be made within the scope described in the claims.

### (Supplementary Note D1)

A prediction device including at least one processor, in which
the at least one processor executes:
acquisition processing of acquiring, by at least one processor, a first pair including a calculation resource amount that is a constraint on a calculation resource amount used for learning processing of a language model for a target language and a target language resource amount that is a resource amount of the target language available for the learning processing; and
prediction processing for referring to a combination of a second pair in which at least one of the calculation resource amount and the target language resource amount included in the first pair is different and a second epoch number in which a loss in learning using a calculation resource amount and a target language resource amount included in the second pair is smaller, and predicting a range of a first epoch number in which a loss in learning using the calculation resource amount and the target language resource amount included in the first pair is smaller.

The prediction device may further include a memory. The memory may store a program for causing the at least one processor to execute each of the processing.

### (Supplementary Note D2)

The prediction device according to Supplementary Note D1, in which in the prediction processing, the at least one processor predicts a range of the first epoch number by using a monotonic change in the first epoch number for each of the calculation resource amount and the target language resource amount.

### (Supplementary Note D3)

The prediction device according to Supplementary Note D1, in which the calculation resource amount included in the second pair is smaller than the calculation resource amount included in the first pair.

### (Supplementary Note D4)

The prediction device according to any one of Supplementary Notes D1 to D3, in which
the first epoch number is a number of epochs in which a loss in learning using the calculation resource amount and the target language resource amount included in the first pair is minimized, and
the second epoch number is a number of epochs in which a loss in learning using the calculation resource amount and the target language resource amount included in the second pair is minimized.

### (Supplementary Note D5)

The prediction device according to any one of Supplementary Note D1 to D4, in which the at least one processor further executes output processing of outputting information indicating at least one of the second pair and the second epoch number relevant to the second pair, and a range of the first epoch number.

### [Supplementary Information E]

The present disclosure includes technologies described in the following Supplementary Notes. However, the present disclosure is not limited to the techniques described in the following supplementary notes, and various modifications can be made within the scope described in the claims.

### (Supplementary Note E1)

A non-transitory recording medium having stored therein a prediction program for causing a computer to function as a prediction device, in which the computer executes:
acquisition processing of acquiring a first pair including a calculation resource amount that is a constraint on a calculation resource amount used for learning processing of a language model for a target language and a target language resource amount that is a resource amount of the target language available for the learning processing; and
prediction processing of referring to a combination of a second pair in which at least one of the calculation resource amount and the target language resource amount included in the first pair is different and a second epoch number in which a loss in learning using a calculation resource amount and a target language resource amount included in the second pair is smaller, and predicting a range of a first epoch number in which a loss in learning using the calculation resource amount and the target language resource amount included in the first pair is smaller.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. A prediction device comprising:
a memory that stores instructions; and
a processor that is configured, according to the instructions, to execute:
acquiring a first pair including a calculation resource amount that is a constraint on a calculation resource amount used for learning processing of a language model for a target language and a target language resource amount that is a resource amount of the target language available for the learning processing; and
referring to a combination of a second pair in which at least one of the calculation resource amount and the target language resource amount included in the first pair is different and a second epoch number in which a loss in learning using a calculation resource amount and a target language resource amount included in the second pair is smaller, and predicting a range of a first epoch number in which a loss in learning using the calculation resource amount and the target language resource amount included in the first pair is smaller.

2. The prediction device according to claim 1, wherein the predicting includes predicting a range of the first epoch number by using a monotonic change in the first epoch number for each of the calculation resource amount and the target language resource amount in machine learning.

3. The prediction device according to claim 1, wherein the calculation resource amount included in the second pair is smaller than the calculation resource amount included in the first pair.

4. The prediction device according to claim 1, wherein
the first epoch number is a number of epochs in which a loss in learning using the calculation resource amount and the target language resource amount included in the first pair is minimized, and
the second epoch number is a number of epochs in which a loss in learning using the calculation resource amount and the target language resource amount included in the second pair is minimized.

5. The prediction device according to claim 1, wherein further the processor is configured, according to the instructions, to execute:
outputting information indicating at least one of the second pair and the second epoch number relevant to the second pair, and a range of the first epoch number.

6. A prediction method comprising:
acquisition processing of acquiring, by at least one processor, a first pair including a calculation resource amount that is a constraint on a calculation resource amount used for learning processing of a language model for a target language and a target language resource amount that is a resource amount of the target language available for the learning processing; and
prediction processing for referring, by the at least one processor, to a combination of a second pair in which at least one of the calculation resource amount and the target language resource amount included in the first pair is different and a second epoch number in which a loss in learning using a calculation resource amount and a target language resource amount included in the second pair is smaller, and predicting a range of a first epoch number in which a loss in learning using the calculation resource amount and the target language resource amount included in the first pair is smaller.

7. The prediction method according to claim 6, wherein the prediction processing includes predicting a range of the first epoch number by using a monotonic change in the first epoch number for each of the calculation resource amount and the target language resource amount in machine learning.

8. The prediction method according to claim 6, wherein the calculation resource amount included in the second pair is smaller than the calculation resource amount included in the first pair.

9. The prediction method according to claim 6, wherein
the first epoch number is a number of epochs in which a loss in learning using the calculation resource amount and the target language resource amount included in the first pair is minimized, and
the second epoch number is a number of epochs in which a loss in learning using the calculation resource amount and the target language resource amount included in the second pair is minimized.

10. The prediction method according to claim 6, further comprising output processing of outputting information indicating at least one of the second pair and the second epoch number relevant to the second pair, and a range of the first epoch number.

11. A non-transitory computer readable medium having stored therein a prediction program for supporting decision making for causing a computer to function as a prediction device, wherein the computer functions as:
an acquisition means for acquiring a first pair including a calculation resource amount that is a constraint on a calculation resource amount used for learning processing of a language model for a target language and a target language resource amount that is a resource amount of the target language available for the learning processing; and
a prediction means for referring to a combination of a second pair in which at least one of the calculation resource amount and the target language resource amount included in the first pair is different and a second epoch number in which a loss in learning using a calculation resource amount and a target language resource amount included in the second pair is smaller, and predicting a range of a first epoch number in which a loss in learning using the calculation resource amount and the target language resource amount included in the first pair is smaller.

12. The non-transitory computer readable medium having stored therein a prediction program for supporting decision making according to claim 11, wherein the prediction means predicts a range of the first epoch number by using a monotonic change in the first epoch number for each of the calculation resource amount and the target language resource amount in machine learning.

13. The non-transitory computer readable medium having stored therein a prediction program for supporting decision making according to claim 11, wherein the calculation resource amount included in the second pair is smaller than the calculation resource amount included in the first pair.

14. The non-transitory computer readable medium having stored therein a prediction program for supporting decision making according to claim 11, wherein
the first epoch number is a number of epochs in which a loss in learning using the calculation resource amount and the target language resource amount included in the first pair is minimized, and
the second epoch number is a number of epochs in which a loss in learning using the calculation resource amount and the target language resource amount included in the second pair is minimized.

15. The non-transitory computer readable medium having stored therein a prediction program for supporting decision making according to claim 11, wherein the computer functions as:
an output means for outputting information indicating at least one of the second pair and the second epoch number relevant to the second pair, and a range of the first epoch number.
